(19) United States
(12) Patent Application Publication
(10) Pub. No.: US 2006/0101391 A1
(43) Pub. Date: May 11, 2006

(54) Spreadsheet application builder

(76) Inventors: Markus Ulke, Heidelberg (DE); Kai Wachter, Dossenheim (DE); Gerhild Krauthauf, Schriesheim (DE)

Correspondence Address: FISH & RICHARDSON, P.C., PO BOX 1022, MINNEAPOLIS, MN, 55440-1022, US

(21) Appl. No.: 10/969,601

(22) Filed: Oct. 19, 2004

(51) Int. Cl. G06F 9/44

(52) U.S. Cl. 717/107

(57) ABSTRACT

Methods and apparatus, including computer program products, that relate to application development and analytical applications. A method of developing an application can include providing application building tools, receiving input, and generating, in a spreadsheet system, an application based on a set of the application elements and a specification of parameters. In that method, the application building tools include a development environment in a spreadsheet system and a set of application elements in the development environment. In addition, the input includes the selection of the subset of application elements from the set of application elements, and the specification of parameters for the application elements.

### BACKGROUND

The following description relates to application development, and more particularly to analytical applications and application builders.

Many businesses use analytical applications (i.e., analytics) to improve business processes by operationalizing decision-making processes. Operationalizing decision-making processes typically includes performing planning or what-if scenarios and may further include an automated action as an end result. Thus, analytical applications apply complex formulae and theories to data that represents past and current trends to generate predictions that can be used to improve business processes. To provide the data for analysis, analytical applications may extract, transform, and integrate data from multiple sources. As an example of how an analytical application may analyze data, an analytical application may apply Tom DeMark Indicators® or Fibonacci scales and analyze repetitious movements to predict future repetitious movements. As an example of how an analytical application may optimize a business process, one analytical application may be able to use past and current trends of an umbrella distributor's stock in a geographical region to determine an optimal amount of umbrellas that should be stocked at any given point in time during a year.

Analytical applications may be used for a variety of aspects of a business, thus analytical applications may include customer relationship analytics, enterprise analytics, supply chain analytics, and marketplace analytics. Customer relationship analytics may measure and optimize customer relationships, and may include campaign management, market exploration, and customer retention analysis. Enterprise analytics may include planning and simulation tools for enterprise applications such as the balanced scorecard. Supply chain analytics may include supplier evaluation, spend optimization, demand aggregation, strategic sourcing, inventory analysis, and manufacturing analysis. Marketplace analytics may provide insight about usage of marketplace offerings through bidding, auctioning, and traffic analysis.

To develop analytical applications and other types of applications, a computer user generally must have knowledge in one or more programming languages, such as machine code, assembly language, C, C++, Java, and the like. However, a computer user may desire to develop applications and that user might not want to expend the effort required for learning a programming language. For example, a computer user may wish to develop a program that is customized for their needs on a single project, but that user might not have a background in any programming languages that might be used to develop the program. Thus, the computer user might be left with undesirable options, such as spending a significant amount of time to learn a programming language or spending a significant sum of money to have a custom-made application.

Newer generations of programming languages and related tools may assist a computer user who wishes to develop an application, as with each new generation of programming languages and their related tools, more and more processes related to application development tend to be automated and simplified. For example, between what is commonly known as second generation (i.e., assembly) and third generation (e.g., C) programming languages, compilers are used to automatically interpret a high level language and generate assembly-level instructions.

### SUMMARY

Described herein are methods and apparatus, including computer program products, that relate to application development and analytical applications.

In one general aspect, a method of facilitating software application development includes receiving in a development environment, where the development environment is capable of generating an application based on a selection of application elements and specified parameters, input including the selection of application elements from a set of application elements, and the specification of parameters for the selection of application elements; and, in a spreadsheet system, generating the application based on the selection of application elements and the specified parameters.

Implementations may include one or more of the following features. The spreadsheet system may include a spreadsheet application. The development environment may provide an interface where application elements can be specified by dragging and dropping the application elements to arrange an object model. The application may be an analytical application. Generating the application may generate the application as an embedded application in a spreadsheet. The set of application elements may include user interface components and data providers. The generated application may be connected to a data repository, where the data repository can store data used by the application for generating analyses. The parameters can be configured in one or more dialog boxes. The parameters can include relationships among the application elements.

In another aspect, a system for developing applications includes a data repository to store a set of application elements; and an application builder configured to generate an application based on an indication of an object model that includes a selection of application elements and a specification of parameters, receive input that includes the indication of the object model, and generate the application based on the received input.

Implementations may include one or more of the following features. The system may further include a spreadsheet-application. The system may further include an interface where application elements can be specified by dragging and dropping the application elements to arrange the object model. The application may be an analytical application. Generating the application may generate the application as an embedded application in a spreadsheet. The application elements may include user interface components and data providers. The generated application may be connected to the data repository, and the data repository may be used to store data used by the application for generating analyses. The parameters may be configured in one or more dialog boxes. The parameters may include relationships among the application elements.

In another aspect, a system for developing applications includes one or more data repositories to store a set of application elements and data for use by an application that is run in a spreadsheet system; and a computer program tangibly embodied on an information carrier that includes instructions operable to cause a computer system to perform operations including receiving input including an indication of an object model, where the object model includes a selection of application elements from the set of application elements, and a specification of parameters that describe relationships among the application elements and/or or the data repositories; and generating the application based on the received input.

The application builder described here may provide one or more of the following advantages. A development environment may be provided, for example, as part of a spreadsheet system. The development environment may enable users without programming skills to build analytical applications by not requiring source code to generate an application. As such, specialized knowledge of a programming language and/or an underlying framework of application development need not be understood to generate applications. In addition, specific application development tools may be directed towards a certain area of application development, thus facilitating building of a specialized application (e.g., by an analytics application). The development environment may include a designtime and a runtime environment, either or both of which may be integrated in a spreadsheet system. The designtime environment may enable an application to be defined via graphical user interface techniques such as dragging and dropping of application elements in combination with configuring dialog boxes that include properties of the application. The runtime may allow an application to be executed in a spreadsheet system, which may advantageously interface with the spreadsheet system, thus using resources such as functions, input interfaces, and output interfaces that are provided via the spreadsheet system. For example, an application may use extraction tools for extracting data from a data container such as a datacube. The application that is developed might be an analytical application, which may be advantageously suited to use resources provided by a spreadsheet system. A definition of an application may be stored as a hidden property of a spreadsheet, which may allow simple deployment of the application, including serialization and deserializtion of the state of the application.

Details of one or more implementations are set forth in the accompanying drawings and the description below. Other features and advantages may be apparent from the description and drawings, and from the claims.

### BRIEF DESCRIPTION OF THE DRAWINGS

These and other aspects will now be described in detail with reference to the following drawings.

FIG. 1 illustrates application development in a spreadsheet system.

FIG. 2A is an illustration of a designtime interface for developing analytical applications.

FIG. 2B is an illustration of a runtime interface of analytical applications.

FIGS. 3A and 3B illustrate dialog boxes for configuring parameters of an analytical application.

FIG. 4 is a flowchart of a method of developing an application in a spreadsheet system.

Like reference numbers and designations in the various drawings indicate like elements.

### DETAILED DESCRIPTION

The systems and techniques described here relate to application development, and more particularly to application builders and analytical applications.

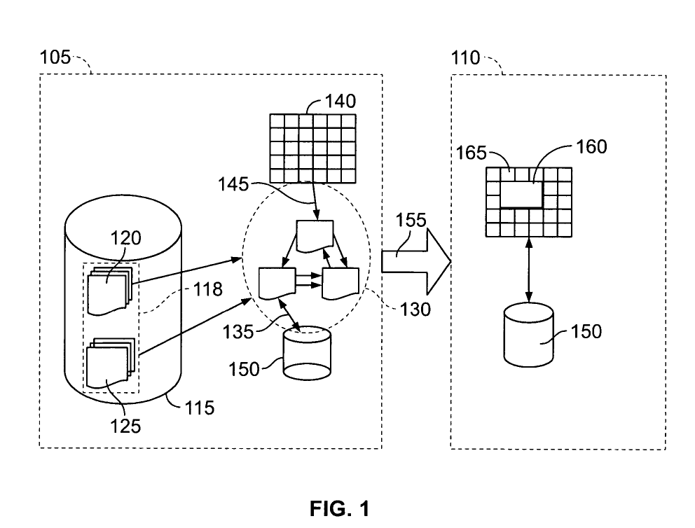

FIG. 1 illustrates application development in a spreadsheet system. The diagram includes a designtime environment 105 for an application being developed and a runtime environment 110 for the application. Both the designtime environment 105 and the runtime environment 110 for developing analytics applications may be an add-in to an existing spreadsheet system. Thus, the ability to develop applications may be easily deployed.

The designtime environment 105 is a development environment that is part of a spreadsheet system. The designtime environment 105 allows a user to define the application from application elements 118 that are stored in a data repository 115. The application elements 118 include user interface components 120 and data providers 125. One or more user interface components 120 can be used to define a user interface for the application. User interface components 120 include grids (i.e., a table with cells that is organized in rows and columns), lists, boxes, checkboxes, maps, charts, dropdown boxes, or buttons. The spreadsheet system includes a spreadsheet application (not shown). In alternative implementations, other types of user interface components may be provided.

The data providers 125 define a selection of data presented to a user interface defined by user interface components 120. The selection of data can be defined by specifying a data repository from which data should be retrieved and/or specifying which data from that data repository should be retrieved, and specifying a user interface component 120 to which the data should be provided. For example, a data provider 125 may define a certain query on a datacube that should be used to define the data to be provided to a user interface element.

Data providers 125 may be defined to perform a combination of tasks prior to presenting data to a user interface component 120. The tasks may include, for example, receiving user input from a user interface, performing events in response to user input, connecting to one or more data repositories, extracting data from one or more data repositories, and performing calculations on data. For example, a data provider may be defined to perform forecasting calculations on data in a data repository to generate results that are presented to a user interface.

The application being developed may be part of a spreadsheet in a spreadsheet system. Thus, a data provider may define how an application interfaces with the spreadsheet system. This may include defining how data is retrieved and presented in the spreadsheet system. For example, an application may interface with spreadsheet cells for receiving input on which to perform calculations. In that example, a data provider may define how the application interfaces with the spreadsheet cells to retrieve input. Thus, a spreadsheet system may provide a front-end through which logic can be imported from a source outside of the application. In addition, features of the spreadsheet system may be customized by adding applications that interface with the spreadsheet system. For example, if a manager of a group of analysts develops an application that can be interfaced with a spreadsheet system, the manager may provide that application to all analysts in the group, thus providing a customized spreadsheet system that includes the application.

To develop an application using the user interface components 120 and the data providers 125, a user selects one or more application elements 118 to develop an object model 130. Relationships between application elements, spreadsheets, and/or data repositories may be defined by parameters. For example, one parameter may define that a set of values from a range of cells in a spreadsheet should be used as input for a function defined by a data provider. As another example, to provide a connection to a data repository 150, the object model 130 includes a parameter that defines a relationship 135. As another example, to provide a connection between the application elements in the object model 130 and the spreadsheet 140, the object model 130 includes a parameter that defines a relationship 145. The object model 130 may or might not be hidden from a user.

Parameters include default parameters and user-defined parameters. For example, some parameters may define a default relationship between a first application element and a second application element. As examples of user-defined parameters, parameters may be defined by a user in a dialog box or by clicking on application elements to indicate relationships among those application elements.

An application builder 155 may generate a runtime version of an application 160. The application builder 155 generates the application 160 based on the object model 130. The runtime version of the application 160 may be stored in a spreadsheet, which may advantageously allow the application 160 to be persisted with the spreadsheet. When the application is stored, the state of the application is serialized (i.e., all properties of the application elements are serialized). Then, when a runtime version of the application is generated, the state of the application is deserialized and the object model is recreated.

The runtime version of the application 160 is embedded in a spreadsheet 165. The application 160 includes a user interface that connects with the data repository 150 via the spreadsheet 165. In contrast to the designtime version of the application, the runtime version of the application 160 is executable. The application 160 may be an analytical application that can provide analytics results to the spreadsheet 165. The analytics results may be results of calculations on data that may be provided via the user interface of the application 160, the spreadsheet 165, and/or the data repository 150. Because both the designtime and runtime environments 105 and 110 of an application may be in a spreadsheet system, a user may advantageously have a single interface (i.e., the spreadsheet system) from which to develop and run an application. In alternative implementations the designtime 105 and/or the runtime 110 need not be included in a spreadsheet system.

In other implementations the application 160 may connect directly to the data repository 150 and need not connect via the spreadsheet 165. The application 160 may use extensible markup language for analysis (“XMLA”; specification available from the XMLA council at http://xmla.org) as a messaging interface to connect the application 160 to the data repository 150.

Although applications are developed in FIG. 1 according to a division of user interface components 120 and data providers 125, other types of application elements may be provided. For example, one type of application element may define both a user interface component 120 and a data provider 125 as a single type of application element. In that case, that type of application element may be combined with other application elements to define an application. Also, although FIG. 1 is discussed with reference to specific types of user interface components 120 and data providers 125, in alternative implementations any type of user interface components 120 and/or data providers 125 may be provided.

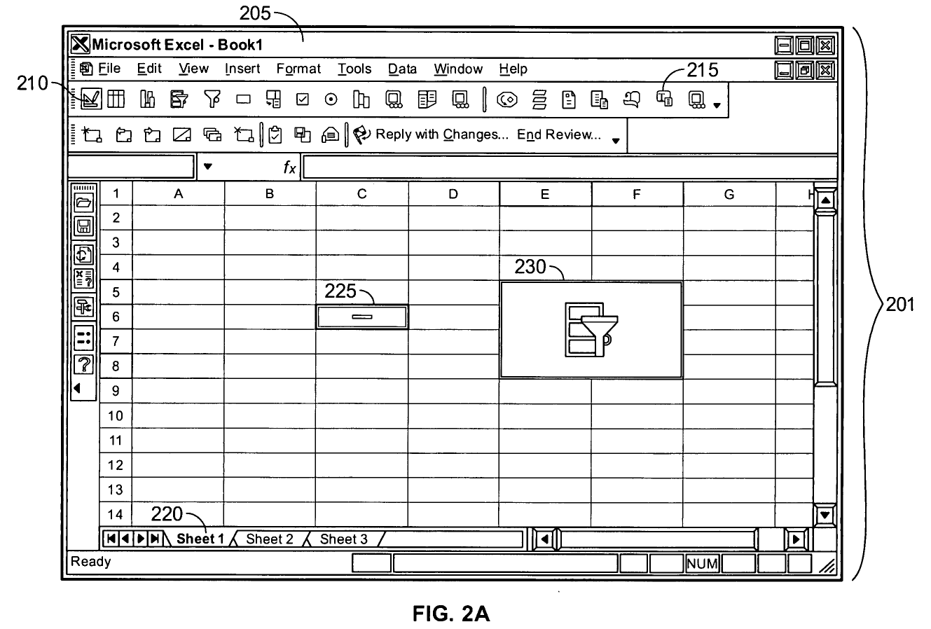

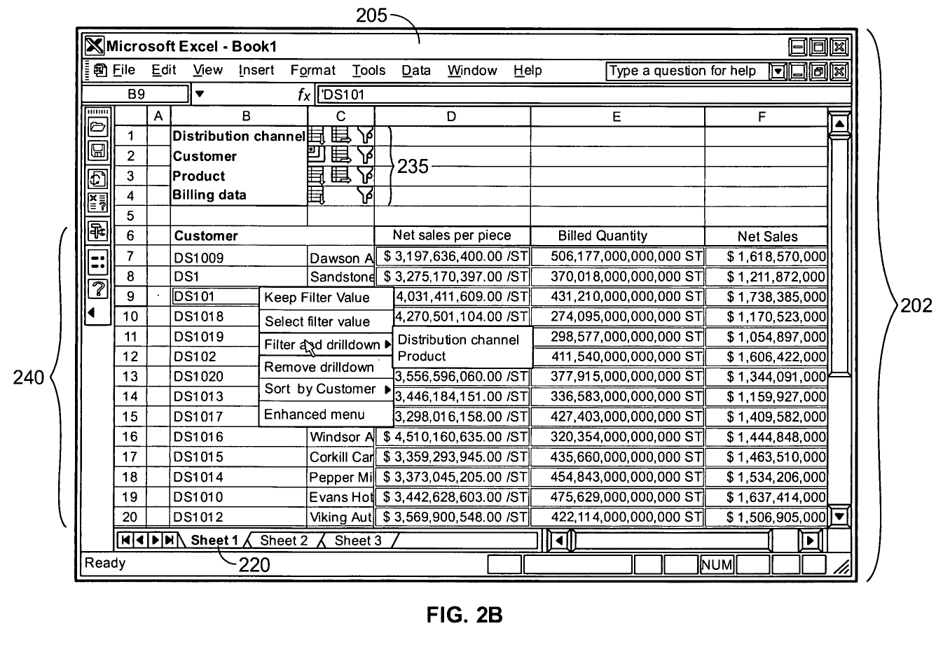

FIG. 2A is an illustration of a designtime environment 201 for developing analytical applications. The designtime environment 201 includes a spreadsheet system 205, such as Microsoft® Excel 2003™. The spreadsheet system 205 includes a toggle button 210; application element buttons, including the application elements button 215; and a spreadsheet 220.

The toggle button 210 is used to switch between a designtime and runtime environment for analytical applications. Thus, if a user clicks on the toggle button 210, the application elements 225 and 230 may switch from a designtime representation to a runtime representation that may be depicted in FIG. 2B. The toggle button provides a strong division between designtime and runtime, as shown between FIG. 2A and FIG. 2B. This strong division and simplified user interface for switching between environments may allow for instantaneous development and debugging of applications. Although a spreadsheet system may have a strong division between designtime and runtime environments for building an application, other data and information in a spreadsheet might not be affected by the change between the designtime and runtime environment. For example, data values in a cell may be unmoved and unchanged by a toggle between the designtime and runtime environments.

A designtime environment 201 enables users to edit applications that are being developed. In FIG. 2A an application is being developed that includes application elements 225 and 230, which are user interface components. In addition, the application may include data providers (not shown).

Development of an application can start when a user clicks on the button 215 shown in FIG. 2A. Each application element has a corresponding application button such as the button 215. When the application button 215 is clicked on, an application element is generated and that application element can be dragged and dropped around the spreadsheet 220. Dropping application elements into one or more cells in the spreadsheet 220 indicates where a user desires to have an interface of an application being developed appear in a runtime environment. Two or more application elements can be dropped into the same set of cells, indicating that the application elements may be part of the same object model from which an application can be generated. As another method or technique of indicating a relationship among application elements, parameters can be configured that define relationships among application elements. In alternative implementations, other mechanisms and/or techniques may be provided for developing an application from application elements. For example, some implementations may provide a wizard that helps a user choose application elements from a list of application elements. The wizard may also help a user choose parameters for the application elements. Also, although the designtime environment 201 in FIG. 2A does not provide a WYSIWYG (“what you see is what you get”) view of an application being developed, in alternative implementations a designtime environment 201 may provide such a view.

To define a layout of an application, the user may move user interface elements by dragging and dropping, or resizing user interface elements. As another technique of defining a layout, a user may use dialog boxes to define properties of the user interface. In accordance with that technique, the user interface may be customized by other ways, in the dialog box. For example, one row of data may be hidden or shown by clicking on a checkbox in a dialog box.

FIG. 2B is an illustration of a runtime environment 202 that includes an analytical application. FIG. 2B may be a runtime environment 202 for the application that was being developed in FIG. 2A. In contrast to a designtime environment, the runtime environment 202 provides an executable version of an application. Thus, for example, a user may interact with an application and the application may perform tasks that provide results to runtime interfaces of the application.

A single embedded analytical application, including two user interfaces, navigation block 235 and grid 240, are depicted in FIG. 2B. The navigation block 235 and the grid 240 may correspond to the application elements 235 and 240, respectively. The navigation block 235 is a type of user interface element that receives a specification of data that should be used to provide analytics results. This specification includes a specification of a datacube (i.e., a multidimensional database that may be in one or more data repositories) and a range of data in the datacube that should be used. In response to receiving a specification of data that should be used, the grid 240 may update to reflect analytics results generated from the specified data. To fine-tune the results and/or how the results are presented, the grid 240 is defined to have a context menu that is context-sensitive for each cell in the grid 240 (i.e., different context menus may be provided depending on the cell from which a context menu is caused to be displayed).

A spreadsheet system need not be used as the designtime and/or runtime environment. For example, an application may be built outside of a spreadsheet system and that application may later be embedded in a spreadsheet of a spreadsheet system. Although FIGS. 2A and 2B are discussed in reference to an analytical application, other types of applications may be developed and/or run using the same or similar techniques and/or mechanisms.

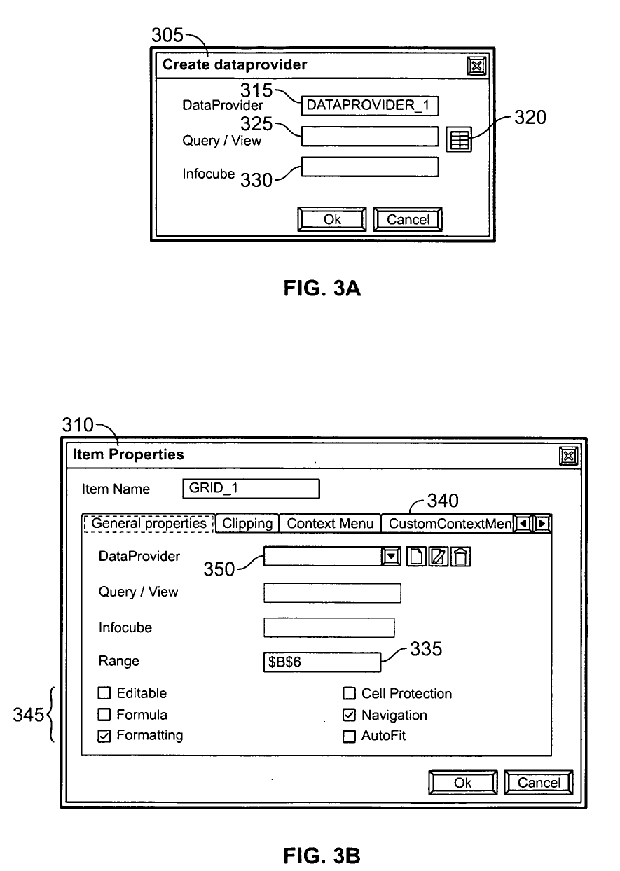

FIGS. 3A and 3B illustrate dialog boxes for configuring parameters of an analytical application. Dialog box 305 includes a dialog box for indicating parameters of a data provider. A data provider is a type of application element that, among other tasks, provides data to a user interface component. The other tasks may include performing calculations, receiving user input via a user interface component, performing events in response to user input, extracting data from one or more data repositories, and the like.

Parameters that can be configured in the dialog box 305 include a name of a data provider (i.e., the data provider that is being configured), a parameter indicating a data repository, and a property indicating a view of that data repository (i.e., a selection of data from the data repository; e.g., a query on an infocube (i.e., a type of datacube) provides a selection of data from the infocube). The name of the data provider can be configured in a text field 315. The parameters relating to the data repository can be configured by the button 320 and the text fields 325 and 330.

The dialog box 310 illustrates a dialog box that can be used to configure properties of a user interface component. A user interface component presents data to a user interface and can provide an interface for interactions with a user. To present data to a user interface, a user interface component may be defined to interface with a spreadsheet system (i.e., a software program that has a user interface). As an example, a user interface component corresponding to the dialog box 310 has a text field 335 for configuring a range of cells that indicate the location of the user interface component. Other parameters may define how a user interface component can interface with a user and/or a spreadsheet system. Those parameters may include, as examples, parameters that define context menu items in a table 340, or parameters that define formatting, navigation, auto-fit properties, cell protection properties, and the like by a series of checkboxes 345.

Parameters of a user interface component may be configured in the dialog box 310. For example, a parameter defining the relationship of the user interface component (i.e., the user interface component that can be configured in the dialog box 310) to a data provider may be defined by selecting a data provider from the drop-down list box 350.

In alternative implementations, other parameters related to a data provider or user interface component may be configured by a dialog box in addition the parameters illustrated in FIGS. 3A and 3B. Although a dialog box is used to configure parameters in FIGS. 3A and 3B, other types of mechanisms, such as a wizard, may be used to configure parameters related to a data provider or a user interface component.

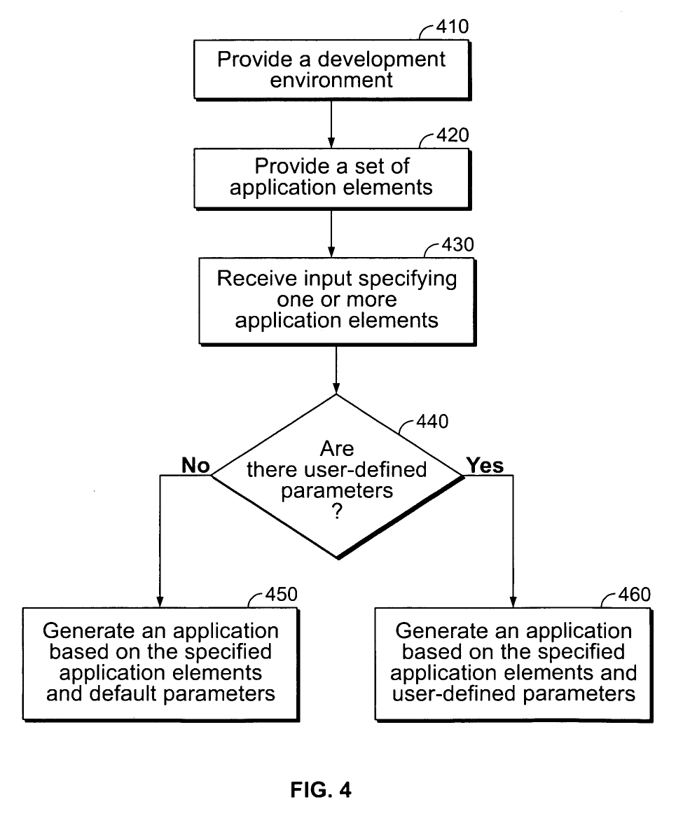

FIG. 4 is a flowchart of a method of developing an application in a spreadsheet system. The method results in an application that may be part of a spreadsheet. The application may be an analytical application, which may advantageously use the spreadsheet and/or spreadsheet system for interfacing for input and output. In addition, an application such as an analytical application may advantageously use functionality of a spreadsheet system, such as functions that perform analytics calculations.

At 410, a development environment is provided. The development environment may be provided to a user of a computer system. A development environment includes tools that can be used to develop an application. The development environment that is provided may be a spreadsheet system that includes tools for developing an application, such as, for example, an analytical application.

At 420, a set of application elements is provided. Application elements are elements that can be combined to define an application, such as an analytical application. The application elements may be provided as part of the development environment. For example, a spreadsheet system that includes tools for developing applications may be bundled with application elements that can be used to develop applications. The application elements can be defined such that source code, or other types of computer-interpretable instructions need not be used to generate an application from the application elements. However, in some implementations, source code may be used to further define an application. For example, more experienced developers may wish to customize certain aspects or add functionality to application elements.

At 430, input is received that specifies one or more application elements. The specified application elements can be from the set of specified application elements. The specified application elements are specified as a combination of application elements that should be used to generate an application.

At 440, a determination is made as to whether there are user-defined parameters. Parameters can define relationships among application elements or properties of application elements. Thus, parameters may be used in conjunction with the specified application elements to define an object model of an application.

At 450, parameters have not been specified, thus an application is generated using default parameters and the specified application elements. Default parameters may be defined for application elements. The default parameters may define, for example, how certain application elements should relate to one another in the case that parameters are not user-defined.

At 460, user-defined parameters and the specified application elements are used to generate an application. User-defined parameters may be defined using any combination of techniques and/or mechanisms. For example, parameters may be defined by a user in dialog boxes that correspond to each of the specified application elements.

Although the method of FIG. 4 is shown as being composed of a certain number and type of processes, additional and/or different processes can be used instead. Similarly, the processes need not be performed in the order depicted.

The disclosed subject matter and all of the functional operations described herein can be implemented in digital electronic circuitry, or in computer software, firmware, or hardware, including the structural means disclosed in this specification and structural equivalents thereof, or in combinations of them. The disclosed subject matter can be implemented as one or more computer program products, i.e., one or more computer programs tangibly embodied in an information carrier, e.g., in a machine-readable storage device or in a propagated signal, for execution by, or to control the operation of, data processing apparatus, e.g., a programmable processor, a computer, or multiple computers. A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes and logic flows described herein, including the method steps of the disclosed subject matter, can be performed by one or more programmable processors executing one or more computer programs to perform functions of the disclosed subject matter by operating on input data and generating output. The processes and logic flows can also be performed by, and apparatus of the disclosed subject matter can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user, the disclosed subject matter can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The disclosed subject matter can be implemented in a computing system that includes a back-end component (e.g., a data server), a middleware component (e.g., an application server), or a front-end component (e.g., a client computer having a graphical user interface or a Web browser through which a user can interact with an implementation of the disclosed subject matter), or any combination of such back-end, middleware, and front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

The following is claimed:

1. A method of facilitating software application development, the method comprising:
receiving in a development environment, the development environment capable of generating an application based on a selection of application elements and specified parameters, input comprising:
the selection of application elements from a set of application elements, and
the specification of parameters for the selection of application elements; and
in a spreadsheet system, generating the application based on the selection of application elements and the specified parameters.

2. A method in accordance with claim 1, wherein the spreadsheet system comprises a spreadsheet application.

3. A method in accordance with claim 1, wherein the development environment provides an interface where application elements can be specified by dragging and dropping the application elements to arrange an object model.

4. A method in accordance with claim 1, wherein the application is an analytical application.

5. A method in accordance with claim 1, wherein generating the application comprises generating the application as an embedded application in a spreadsheet.

6. A method in accordance with claim 1, wherein the set of application elements comprises user interface components and data providers.

7. A method in accordance with claim 1, wherein the generated application is connected to a data repository, the data repository to store data used by the application for generating analyses.

8. A method in accordance with claim 1, wherein the parameters are configurable in one or more dialog boxes.

9. A method in accordance with claim 1, wherein the parameters comprise relationships among the application elements.

10. A system for developing applications, the system comprising:
a data repository configured to store a set of application elements; and
an application builder configured to:
generate an application based on an indication of an object model comprising a selection of application elements and a specification of parameters,
receive input comprising the indication of the object model, and
generate the application based on the received input.

11. A system in accordance with claim 10 further comprising a spreadsheet application.

12. A system in accordance with claim 10 further comprising an interface where application elements can be specified by dragging and dropping the application elements to arrange the object model.

13. A system in accordance with claim 10, wherein the application is an analytical application.

14. A system in accordance with claim 10, wherein the application is generated as an embedded application in a spreadsheet.

15. A system in accordance with claim 10, wherein the application elements comprise user interface components and data providers.

16. A system in accordance with claim 10, wherein the generated application is connected to the data repository, the data repository being further configured to store data used by the application for generating analyses.

17. A system in accordance with claim 10, wherein the parameters are configurable in one or more dialog boxes.

18. A system in accordance with claim 10, wherein the parameters comprise relationships among the application elements.

19. A system for developing applications, the system comprising:
one or more data repositories to store a set of application elements and data for use by an application that is run in a spreadsheet system;
a computer program tangibly embodied on an information carrier, the computer program product comprising instructions operable to cause a computer system to perform operations comprising:
receive input comprising an indication of an object model, the object model comprising:
a selection of application elements from the set of application elements, and
a specification of parameters that describe relationships among the application elements and/or the data repositories; and
generate the application based on the received input.
